(19) United States
(12) Patent Application Publication
(10) Pub. No.: US 2013/0320594 A1
(43) Pub. Date: Dec. 5, 2013

(54) METHODS FOR RECYCLING POST-CONSUMER MIXED RIGID PLASTICS

(71) Applicants: Keith Bechard, Toronto (CA); Mohamad Mogharab-Rahbari, London (CA)

(72) Inventors: Keith Bechard, Toronto (CA); Mohamad Mogharab-Rahbari, London (CA)

(21) Appl. No.: 14/000,124

(22) PCT Filed: Feb. 17, 2012
(86) PCT No.: PCT/CA12/00159

§ 371 Date: Aug. 16, 2013

Related U.S. Application Data
(60) Provisional application No. 61/444,402, filed on Feb. 18, 2011.

(51) Int. Cl. B29B 17/02

(52) U.S. Cl. CPC B29B 17/02
USPC 264/344

(57) ABSTRACT

The present invention relates to methods for the recovery and processing of mixed rigid plastics. In one embodiment the present invention relates to a method of processing recovered plastic flakes for an intended end-use application, that includes the following steps: (a) breaking the bale apart and sorting the mixed rigid plastics in the broken bale into streams of plastic materials, said sorting including resin type and physical properties of the plastic materials; (b) washing one or more of the streams of plastic materials to obtain clean flakes of plastic material in each stream; (c) comminuting the plastic flakes in one or more of the streams into particles of plastic material; and (d) compounding the particles of plastic material in one or more of the streams to obtain one or more plastic products configured for the intended end-use application.

This application claims priority of U.S. Provisional Application No. 61/444,402, filed Feb. 18, 2011, the contents of each of which are hereby incorporated by reference into the present disclosure.

### 1. FIELD OF THE INVENTION

This invention relates to methods for the recovery of mixed rigid plastics. More particularly, the present invention relates to methods for processing recycled plastics recovered from mixed rigid plastics to obtain plastic products suitable for intended end-use applications.

### 2. BACKGROUND

To assist recycling of disposable items, the Plastic Bottle Institute of the Society of the Plastics Industry devised a now-familiar scheme to mark plastic bottles by plastic resin identification code. Seven different plastics are identified by this scheme: (1) PET (PETE), polyethylene terephthalate, is commonly found in 2-liter soft drink bottles, water bottles, cooking oil bottles, peanut butter jars; (2) HDPE, high-density polyethylene, is commonly found in detergent bottles and milk jugs; (3) PVC, polyvinyl chloride, is commonly found in plastic pipes, outdoor furniture, siding, floor tiles, shower curtains, clamshell packaging; (4) LDPE, low-density polyethylene, is commonly found in dry-cleaning bags, produce bags, trash can liners, and food storage containers; (5) PP, polypropylene, is commonly found in bottle caps, drinking straws, yogurt containers; (6) PS, polystyrene, is commonly found in “packing peanuts”, cups, plastic tableware, meat trays, take-away food clamshell containers; and (7) other types of plastics commonly found in certain kinds of food containers.

Although all plastics designated with 1-7 can be recycled, the non-uniform attributes of post-consumer mixed rigid plastics has limited the recycling of post-consumer plastics. To date the predominant focus in post-consumer plastics recycling has been clear and green PET (No “1”) beverage bottles, and HDPE (No “2”) bottles. These two forms of post-consumer plastics constitute approximately 50% of the rigid post-consumer plastics generated. The remaining forms of post-consumer plastic wastes generated consist of a variety of common consumer products such as: various clear PET thermoform packaging (bakery clamshells, fruit and vegetable trays), coloured PET bottles and thermoforms, “dual ovenable” CPET trays, non beverage bottles, jars or cutlery made from PET, PP bottles, wide mouth tubs and lids, non-detergent bottles made from HDPE, LDPE and PP; PVC bottles, PVC thermoform packaging, PS trays, PS clamshells; and large IPE or PP pails and lids. The most significant challenge to recycling post-consumer plastics has been the non-uniform attributes of the plastics including variability in: size, resin type; colour; melt flow; functional additives used, filler composition and contaminants.

Another obstacle to the recycling of post-consumer mixed rigid plastics as mentioned in U.S. Pat. No. 5,142,308 is the disparity found in the content from bale to bale. Bales generally contain a mixture of containers of different plastics, and the proportion of containers of particular plastics vary from bale to bale. In addition, the composition of the bales also varies from source to source. As a result of these obstacles much of the post-consumer plastic generated globally is destined for either incinerators or landfills. The most sustainable and ecological method of dealing with this waste stream is to recycle it.

PET is produced by a condensation reaction of ethylene glycol and terephthalic acid. It is a slow crystallizing polymer having a glass transition temperature Tg, of about 70° C. and a crystalline melting temperature Tm of about 265° C. The crystalline state is characterized by a relatively low crystallization rate and a relatively low value of the maximum crystallinity. The large amount of amorphous polymer causes semicrystalline PET to be quite tough but rubbery, not stiff, in the temperature range between Tg and Tm.

PET is widely used as an extrusion and injection-molding resin for the fabrication of various articles for household or industrial use, including appliance parts, containers, and auto parts. PET also is commonly extruded into sheet (including film) of various thicknesses, which may be used as-fabricated or shaped, e.g., by thermoforming, into articles such as display articles, signs, or packaging articles. For example, extruded PET sheet material can be used to make trays, packages or containers in which foods may be both stored and heated and/or cooked. As used herein, the terms “tray” and “trays” include packages and containers in which food is packaged and sold for subsequent heating and/or cooking while still in the tray, package or container. Food trays fabricated from crystallized PET (CPET) retain good dimensional stability over the range of temperatures commonly encountered during both microwave and conventional oven cooking (known as “dual ovenable”) (see U.S. Pat. No. 6,986,864).

The manufacture of thin-walled containers (trays) using the thermoforming process is well-known in the art. Such polyester food trays typically are manufactured by first extruding a sheet of polyester, then thermoforming the tray in a heated mold. Specific processes for extruding polyester sheeting and thermoforming the sheet material to produce CPET food trays are also well known, for example, as described by Siggel et al. in U.S. Pat. No. 3,496,143 (see U.S. Pat. No. 6,986,864, herein after “U.S. '864”).

The thermoforming process both forms the shape of the tray and crystallizes the polyester resin. The manufacture of this type of polyester article requires that it be initially formed from substantially amorphous polyester sheet. Crystallization is then accomplished by means of holding the polyester at a temperature between its glass transition temperature (Tg) and the crystalline melting temperature (Tm) while in the mold. Crystallization of the sheet in its final shape produces the desired high temperature stability of the thermoformed article. The sheet material used may be prepared in a process separate from the thermoforming process (sometimes referred to as the roll-fed or in-line process) which uses sheet heated from below the glass transition temperature. Alternatively, the sheet material may be prepared in-line with the thermoforming process such that the melt may not vitrify or vitrify completely before contact with the mold (sometimes referred to as the melt-to-mold process) (see U.S. '864).

“In the “roll-fed” or “in line” process, as disclosed in U.S. Pat. No. 3,496,143, the thermoforming process both forms the shape of the tray and crystallizes the polyester, which is supplied as a vitrified (amorphous) film. Polyester obtained from the melt is amorphous, and development of significant crystallinity is necessary to obtain the desired physical properties. In this first process, amorphous polyester sheet (film) is heated, and then supplied to a heated mold, for example a mold formed between two heated platens. Crystallization is then accomplished by holding the polyester at a temperature between its glass transition temperature, Tg, and its crystalline melt temperature, Tm. Crystallization of the sheet in its net shape produces the desired high temperature stability of the thermoformed article, and allows its removal from the mold without damage. Thus, in this first process, the polyester is heated from below its glass transition temperature to a temperature range in which crystallization can occur. (see U.S. Pat. No. 7,279,124)

The foregoing process requires preparation and storage of an amorphous polyester film. Unmodified, crystallizable polyesters such as polyethylene terephthalate (PET) crystallize slowly when cooled from the melt or heated from below the glass transition temperature. To obtain acceptable manufacturing economics, it is necessary that the rate of thermal crystallization in the mold be rapid. However, at the same time, the crystallization rate upon cooling from the melt must be such that an amorphous film can be prepared, (see U.S. Pat. No. 7,279,124)

In the melt-to-mold thermoforming processes, the polyester sheet is extruded directly before thermoforming, and is thermoformed prior to complete vitrification. In contrast to the roll-fed process where the polyester sheet is heated from below its Tg, in the melt-to-mold process, the polyester is at or above its Tg. Thus, the crystallization process is completely different, and it has been found, in general, that crystallization nucleators eminently suitable for the roll-fed process are ill-suited for the melt-to-mold process. The differences in crystallization due to the thermal history of the polyester is discussed by D. W. van Krevelen, CHIMIA, 32 (1978), p. 279, where large differences in nucleation density are observed with differences in thermal history, i.e. depending upon whether the polymer is heated from below the glass transition temperature or cooled from the melt to the crystallization temperature (see U.S. Pat. No. 7,279,124).

A well-known method to increase the rate of crystallization is to incorporate a crystallization nucleator into the polyester. These crystallization rate enhancers typically are inorganic or organic solids finely dispersed throughout the polyester. Such nucleators typically are used at a concentration, relative to the polyester being nucleated, of at least 0.05% by weight (see U.S. '864).

The selection of crystallization nucleators in thermoforming of crystallizable polyesters is further complicated by the additives generally employed. Such additions typically include fillers, pigments, and most importantly, impact modifiers (see U.S. '864).

One characteristic of typical crystallization nucleators well-known in the art, such as talc, is that they promote crystallization during cooling from the melt as well as during heating from below the glass transition temperature. For example, an article injection molded from typical nucleated polyester crystallizes to at least some degree while in the injection mold. This is desirable if the object is to produce a crystalline injection molded part. If, however, the object is to produce an amorphous part, such as an extruded sheet, crystallization from the melt is objectionable because it may interfere with subsequent operations, such as thermoforming. The best additives for enhancing the processing are those that will enhance crystallization on heating from below the glass transition temperature, and ideally have little or no enhancement (or even suppression) of crystallization rate when cooling from the melt (see U.S. '864).

Nucleators which facilitate crystallization and have been used in polyester molding and roll-fed thermoforming processes include poly(tetramethylene terephthalate) polyesters; metal salts of polyesters as disclosed by U.S. Pat. No. 5,405,921; combinations of inorganic compounds with polyester compositions having specific end group chemistry as disclosed in U.S. Pat. No. 5,567,758; sodium compounds and wax, as disclosed in U.S. Pat. No. 5,102,943; poly(butylene terephthalate), copolyetheresters, or nylon 6,6, as disclosed in Research Disclosure 30655 (October 1989); polyester elastomers in polyethylenenaphthalate polyesters, as disclosed in U.S. Pat. No. 4,996,269; poly(oxytetramethylene) diol, as disclosed in U.S. Pat. No. 3,663,653; ethylene-based ionomers in block copolyesters as disclosed in U.S. Pat. No. 4,322,335; polyoxyalkylene diols as disclosed in U.S. Pat. No. 4,548,978; alkali metal salts of dimer or timer acids, as disclosed in U.S. Pat. No. 4,357,268; sodium salts of fatty acids in conjunction with alkyl esters of a C.sub.2-8 carboxylic acid as disclosed in U.S. Pat. No. 4,327,007; partially neutralized salts of a polymer containing neutralizable groups, as disclosed in U.S. Pat. No. 4,322,335; neutralized or partially neutralized salts of montan wax or montan wax esters as disclosed in U.S. Pat. No. 3,619,266; epoxidized octyloleate together with sodium stearate, as disclosed in U.S. Pat. No. 4,551,485; and amino-terminated polyoxyalkylene polyethers as disclosed in U.S. Pat. No. 5,389,710.

In U.S. Pat. No. 7,279,124 aliphatic polyamides are proposed as highly effective and tailorable crystallization nucleators in crystallizable polyester compositions and which are suitable for use with additives typically employed in polyesters used to prepare thermoformed products by the “melt-to-mold process.

Fast crystallization rates are not the only consideration for successful implementation of CPET for food containers, however. One problem encountered with polyester food trays is that they can suffer from poor impact properties, especially at low temperatures. The impact properties of food trays may be affected detrimentally by the presence of some nucleating agents, especially inorganic nucleating agents. One way to improve the impact properties (toughness) of these articles is to use high molecular weight polyester in the fabrication of the tray. Therefore, polyester used in food trays often is specially manufactured to produce intrinsic viscosities (IVs) of about 0.90 to about 1.05 dL/g. Another approach is to add an impact modifier to the polyester composition. In general, trays are toughest when both approaches are utilized. The presence of majority amounts of polyester in the composition provides the other necessary properties such as tensile strength, stiffness and temperature resistance. Of the impact modifiers used in polyester compositions, terpolymers based on ethylene, an alkyl acrylate and glycidyl acrylate, or blends of similar polymers provide an attractive combination of properties in this application, e.g., as disclosed by Epstein in U.S. Pat. No. 4,172,859 and Deyrup in Published PCT Application WO 85/03718, though other impact modifying agents may be used (see U.S. '864).

The prior art as it relates to the incorporation of nucleators, impact modifiers, thermal stabilizers, and other general additives such as pigment and fillers into PET has primarily been discussed in terms of extrusion. Compounding methods well known in the art primarily consists of heating the plastic beyond its melting temperature, and mixing the various forms of solid or liquid additives with the molten plastic, homogenizing it, and cooling the output to form pellets or sheets. In plastics processing single, or twin-screw extruders are the common technology used to compound formulations of plastics.

Melt compounding through such processes as extrusion adds an additional heat history to the material. In particular when dealing with reprocessing post-consumer PET into a recycled PET (RPET) pellet the IV degradation resulting from the additional heat history is undesirable. For “dual ovenable” CPET food trays it is desirable to produce intrinsic viscosities (IVs) of about 0.90 to about 1.05 dig. In order to be able to use RPET for the production of CPET the IV of the RPET would have to be increased from an average of around 0.76 to the above stated desirable values.

U.S. Pat. No. 6,997,407 (U.S. '407), the content of which are incorporated herein by reference, discloses a process for decontaminating RPET flakes. The process consists of comminuting the RPET flakes to prepare RPET particles having an average size from about 0.0005 inch to about 0.05 inch in diameter, and driving the contaminants out of the RPET particles. U.S. '407, however, does not teach, suggest or address the upgrading of the RPET particles or any other non-virgin plastic.

It would be desirable to develop a process able to upgrade post-consumer or non-virgin plastics obtained from a bale of mixed rigid plastics for intended end-use applications such as “dual ovenable” CPET applications. Upgrading may involve the addition of nucleating agents, impact modifiers, and pigment to the non-virgin plastic, and in the case of PET, increasing the IV build to produce a final pellet formulation that could be used to produce such intended end-use applications. It would be further desirable if the entire process of decontamination, IV build, and compounding with additives could be achieved in a simple process with no need to re-melt the recycled plastic (no additional heat history). The capital and operating costs of this process should be economically competitive and provide benefits to the food packaging industry for the technology to be truly disruptive.

### 3. SUMMARY OF THE INVENTION

In one embodiment, the present invention relates to a method of processing recovered plastic flakes for an intended end-use application. The method, in one embodiment, includes: (a) comminuting the plastic flakes into particles; and (b) compounding the particles to obtain plastic products configured for the intended end-use application.

In another embodiment, the present application relates to a method of processing plastic materials recovered from a mixed rigid plastic bale for an intended end-use application. The method, in one embodiment, includes: (a) breaking the bale apart and sorting the mixed rigid plastics in the broken bale into streams of plastic materials, said sorting including resin type and physical properties of the plastic materials; (b) washing one or more of the streams of plastic materials to obtain clean flakes of plastic material in each stream; (c) comminuting the plastic flakes in one or more of the streams into particles of plastic material; and (d) compounding the particles of plastic material in one or more of the streams to obtain one or more plastic products configured for the intended end-use application.

In one embodiment the streams of plastics include polyethylene terephthalate (PET), high-density polyethylene (HDPE), polyvinyl chloride (PVC), low-density polyethylene (LDPE), polypropylene (PP), polystyrene (PS) or any other type of plastics commonly found in food containers.

In another embodiment the compounding comprises blending the particles with one or more additives to obtain a plastic blend and pelletizing the blend to obtain plastic pellets for the intended end-use application.

In another embodiment the compounding further comprises decontaminating the particles.

In another embodiment one stream of plastic material or plastic flake is a stream of PET and said compounding comprises increasing the intrinsic viscosity (IV) of the particles of PET, and pelletizing the particles of PET having increased IV to obtain plastic pellets for the intended end-use application.

In another embodiment one stream of the plastic material or plastic flake is a stream of PET and said compounding comprises decontaminating the particles of PET, increasing the intrinsic viscosity of the particles of PET, blending the particles of PET with one or more additives, and pelletizing the blend to obtain PET pellets for the intended end-use application.

In aspects of the invention the additives include crystallization nucleating agents, impact modifiers, thermal stabilizers, pigments and fillers.

In aspects of the invention the crystallization nucleating agents include talc, gypsum, silica, calcium carbonate, alumina, titanium dioxide, calcium silicate, fine metal particles, powdered glass, carbon black, mica, graphite, salt of monocarboxylic or polycarboxylic acids, chlorobenzoates, benzophenone, alkylsulfonates, dibenzylidene, sorbitol compounds, alkyl aryl phosphates, cyclic bis-phenol phosphates, acetals of sorbitol and xylitiol, remnants of polycondensation catalyst, polymers comprising polyolefins, various copolymers of ethylene, and styrene derivatives, ionomers, blends of faster crystallizing polymers like PBT, PBN, PA, individually or mixtures of one or more.

In aspects of the invention the impact modifiers include terpolymers. In aspects for PET plastic materials, impact modifiers include: calcium carbonate, elastomers and rubbers, including styrene-butadiene-styrene, polyolefins, including PP or HDPE with GMA (glycidyl Methylacrylate) as compatibilizers, and terpolymers, alone or combined with methylacrylate compatibilizers.

In aspects of the invention the thermal stabilizers include: terephthalic acid (TA), phthalimide (PTI), dimethyl terephthalate (DMT), 4-hydroxy benzoic acid (HBA). 5-hydroxy isophthalic acid (HIPA), 3,5-dihydroxybenzoic acid (DHBA), phenyl isocyonate (PIC), phthalic anhydride (PA), 4-aminobenozic acid (PAB), resorcinol (ROL), or diphenylamine (DPA).

In aspects of the invention, the intended end-use application is the production of dual ovenable food packaging.

In another embodiment, the present invention relates to a method for producing CPET from PET flakes recovered from a mixed rigid plastic bale. The method, in one embodiment, includes: (a) comminuting the PET flakes into particles, (b) blending the PET particles with a sufficient amount of one or more nucleating agents to obtain a blend, and (c) pelletizing the blend into CPET pellets thereby providing CPET from recovered PET flakes.

In one embodiment step (b) includes blending the PET particles with recycled polyethylene (PE) or recycled polypropylene (PP).

In another embodiment the recycled PE or recycled PP are recovered through one of the recovering methods of the present invention.

### 4. DETAILED DESCRIPTION OF THE INVENTION

Unless defined otherwise, all technical and scientific terms used herein have the same meaning as commonly understood by one of ordinary skill in the art to which this invention belongs. Also, unless indicated otherwise, except within the claims, the use of “or” includes “and” and vice versa. Non-limiting terms are not to be construed as limiting unless expressly stated or the context clearly indicates otherwise (for example “including”, “having” and “comprising” typically indicate “including without limitation”). Singular forms including in the claims such as “a”, “an” and “the” include the plural reference unless expressly stated otherwise.

The Applicants have developed a novel mixed rigid recovery process termed RigidReclaim™. The RigidReclaim™ process has surprisingly been found capable of producing compounded C-PET pellets that may be used for any desired application, including “dual ovenable” trays for food packaging applications.

In one embodiment the present invention provides for a method of processing recovered plastic flakes for an intended end-use application. This method may comprise: (a) comminuting the plastic flakes into particles; and (b) compounding the particles to obtain plastic products configured for the intended end-use application.

In another embodiment, the present application relates to a method of processing plastic materials recovered from a mixed rigid plastic bale for an intended end-use application. This method may start by breaking the bale apart and sorting the mixed rigid plastic materials in the broken bale into streams of plastic materials, for example into different segmented streams of plastic materials, the sorting into the streams of plastic materials may include resin type and physical properties of the plastic materials. In one aspect, the broken bale may be sorted into one or more streams of different plastic materials. The streams (or just one stream) of different plastic materials may then be washed so as to obtain clean plastic flakes of each plastic material. The plastic flakes in the streams (or just one stream) may be comminuted into particles of each plastic material. The particles of one or more of the different plastics may be compounded to obtain plastic products of each plastic material configured for the intended end-use application.

### Breaking the Plastic Bales

Mixed rigid plastic bales may consist of commingled mix of various resin types including high density polyethylene (HDPE), low density polyethylene (LDPE), polypropylene (PP), polyethylene terephthalate) (PET), poly(vinyl chloride) (PVC), polystyrene (PS) and their co-polymers, and their derivatives, as well as other resin types which may be found in post-consumer recycled plastics and which may be considered as contaminants. Commingled mix of various colours including naturals and black; commingled mix of packages for each resin type manufactured through: thermoforming, blow moulding, and injection moulding processes exhibiting material mechanical and processing characteristics indicative of the various manufacturing processes used to form the packaging may be received as feedstock for the RigidReclaim™ process.

These co-mingled bales of plastics may be broken apart using any known method, such as de-baler methods and equipment for which are well known in the art of plastics recycling;

The broken bales of plastic may then be processed through various stages of coarse decontamination which may include manual contaminant removal, magnetic belts, star screeners, trommels, air separation and other coarse contaminant removal processes as deemed necessary.

### Sorting the Broken Bales

The plastics in the broken bales may be sorted by resin type, melt flow properties, and colour using a combination of technologies that may include: optical sorting, manual sorting, floatation, specific gravity separation, electrostatic charge separation, and other methods well known in the art for sorting of plastic materials.

### Washing the Plastic Materials

The various segmented streams of plastics may then be washed using various methods well known in the art to wash the various segmented streams of plastics. Through the washing process clean flakes of recycled plastics may be produced which may, for the most part, be free of adhesives, labels, glass, dirt, metals, and other contaminants of concern. The clean flakes of plastic materials may have an average size of about 0.5 cm to about 1.5 cm. Sizes bellow 0.5 cm or above 1.5 may also be used.

In this document, the term “flake” may also refer to generally commercially available plastic materials produced by conventional recycling methods. The flakes may take any form, including as flakes, chunks, pellets, spheres and the like.

Some of the segmented streams of plastics may be further refined to meet specific quality targets for the intended end-use applications. The additional refining of these streams includes processes that deal with the specific contaminants of concern for that segment and may also include flake sorting methods well known in the art of recycling the various segments of plastics produced.

### Comminuting the Plastic Flakes

The washed plastic flakes may be comminuted by any known method in the art to obtain particles of the plastic material. The particles may have an average size of about 150 μm to about 500 μm. Particles of sizes bellow 150 μm or above 500 μm may also be used.

### Upgrading the Comminuted Particles

On or more of the segments of the streams of comminuted particles produced may further upgraded in order to meet intended quality targets for specific end-use applications. The process of upgrading one or more of these various streams may include but is not limited to: incorporation of various functional additives, removal of volatile organics, solid-stating, melt-flow tailoring, polymer chain branching, co-polymerizing, grafting, increasing the molecular weight, and increasing the average length of the polymer chain through methods well known in the art. Mixing the comminuted particles with one or more additives may result in a blend. The upgrading of the blends may then be done using various methods well known in the art including: single, or twin-screw extruders, reactive extruders, reactor vessels, and fluidized bed processes.

Production of CPET Resin from Recycled Plastics

In another embodiment, the present invention relates to a method for producing CPET from PET flakes recovered from a mixed rigid plastic bale (post-consumer mixed plastics feedstock stream). The method may include: (a) comminuting the PET flakes into particles, (b) blending the PET particles with a sufficient amount of one or more nucleating agents to obtain a blend, and (c) pelletizing the blend thereby providing CPET pellets from recovered PET flakes.

In one embodiment, the present invention relates to the production of a CPET resin for use in dual ovenable trays from post-consumer mixed plastics feedstock stream. The process may entail using a combination of optical sorting, manual sorting, specific gravity separation, electrostatic separation, and floatation to recover a highly pure stream of recycled PET. The PET packaging which may consist of all forms of PET present in the post-consumer recycling stream including bottles and thermoforms may be washed through a process specifically to deal with the mix of PET packaging defined as the feedstock to the process. The highly clean and pure stream of recycled PET may be further refined using a combination of flake sorting technologies well known in the art in order to further reduce the contaminants of concerns. The cleaned highly pure recycled PET flakes may then be compounded into C-PET pellets that could be used to produce an intended end-use product, such as “dual ovenable” food packaging. The compounding process may include any of the methods well known in the art, including either the aforementioned “roll-fed” or “melt-to-mold” processes. In one embodiment of the present invention the compounding process includes a process by which the recycled PET is pulverized or comminuted into particles. The particles may have an average particle size of about 150 μm to about 500 μm (it should be understood that more or less than 150 and 500 μm may also be used). The particles may be further decontaminated using a paddle dryer or other methods well know in the art that would allow for continuous agitation of the particles in the presence of hot air in order to diffuse from the particles of plastics any volatile contaminants in the recycled PET. The residence time of the particles within the said paddle dryer may range from about 20 to about 150 minutes. Once the particles are decontaminated, the fine particles may then be upgraded. In one embodiment, the Intrinsic Viscosity (IV) of the PET particles may be increased to achieve a desired IV, for example about 0.9 to about 1.05 dL/g. IV of PET may be increased through poly-condensation reaction. Methods for solid-state molecular weight increase of PET polymer chains are well known in the art. One method may be to fluidize the PET particles in the presence of inert gas such as nitrogen or helium at elevated temperatures of about 180 to about 215 degrees Celsius, preferably at about 195 degrees Celsius for a sufficient period of time. Another such process may be to have the powders continually mixed in an insulated blending silo that is under vacuum conditions for a sufficient period of time at elevated temperatures of about 180 to about 215 degrees Celsius, preferably at about 195 degrees Celsius.

In one embodiment, the PET particles may also be upgraded by adding one or more functional additives. In this embodiment, the PET particles may be transferred to a blending silo where impact modifiers, nucleating agents, pigments, and other forms of functional additives required to meet a desired processing properties may be added and mixed with the particles of PET at specifically metered concentrations.

Production of CPET Using Polyethylene or Polypropylene Resin from Recycled Plastics as the Nucleating Agent

In one embodiment, the present invention includes having either recycled polyethylene (PE) or polypropylene (PP) recovered through the aforementioned RigidReclaim™ process pulverized and decontaminated using a similar process as that described above for the PET in order to produce highly clean, pure, and decontaminated PP and/or PE particles of a size appropriate for homogenization functional additives or with the PET powders. The incorporation of recycled PE and/or PP may serve as impact modifiers and/or as nucleators for the PET. Any nucleator and/or impact modifier and/or pigment and/or other functional additive so desired and well known to the art may be used. The additive incorporated may be either in solid or liquid state, and may be of any material that may be processed into particles of the appropriate size that would enable for complete and thorough homogenization with the PET particles, or sprayed onto the particles using methods well known in the art that would completely homogenize with the PET.

The homogenized blend of PET and nucleator, and/or other additives if so desired, may then be formed into a CPET pellet. The method and equipment for pelletization of the powder are well known in the art and may include single or twin-screw extrusion. It may be beneficial not to have an additional heat history during the pelletization process and a sintered pellet using methods well known to the art of pelletization of solid material could be used to produce the final product.

Nucleating agents that may be used through this process may be inorganic or organic additives such as talc, gypsum, silica, calcium carbonate, alumina, titanium dioxide, calcium silicate, fine metal particles, powdered glass, carbon black, mica, graphite, salt of monocarboxylic or polycarboxylic acids, chlorobenzoates, benzophenone, alkylsulfonates, dibenzylidene, sorbitol compounds, alkyl aryl phosphates, cyclic bis-phenol phosphates, acetals of sorbitol and xylitiol, remnants of polycondensation catalyst, polymers comprising polyolefins, various copolymers of ethylene, and styrene derivatives, ionomers, blends of faster crystallizing polymers like PBT, PBN, PA etc., individually or mixtures of one or more.

The RigidReclaim™ technology described herein responds to both a market opportunity and public policy imperative to recycle consumer packaging waste. The process outcome is the conversion of a commingled, contaminated mixed post-consumer plastic bale into segregated, highly pure and commercially valuable resins. The RigidReclaim™ process is a disruptive technology in plastics recycling and introduces a new level of sustainability to the industry. It integrates commercially proven and proprietary technologies in a manner that is innovative both in terms of sequence and application and in terms of material sorting, resin decontamination and resin upgrading. This process differs from conventional plastics recycling processes which are unable to commercially achieve broad based resin decontamination and upgrading required for high-value end-user markets such as consumer product packaging.

The process has the further advantage of dramatically reducing the infrastructure and cost need for plastics segregation by Material Recovery Facilities (MRFs). The economics of the process are driven by: the lower cost of the feedstock; the ability of the process to produce high quality resins for value-added markets; and the scalability of the process.

In particular the process uses a novel process for the production of nucleated CPET pellet from recycled post-consumer PET.

Advantages of the present invention include:
a) An advantage of the present invention is that it provides for a process that will be able to recycle all rigid post-consumer plastics 1-7 into high value end-use products;
b) Another advantage of the present invention is that the process minimizes down-cycling of plastics through a closed-loop plastic recycling process whereby at least 75% of the post consumer rigid plastics recovered are recycled back into high value consumer packaging products;
c) Yet another advantage of the present invention is that the process enables for greater use of recycled plastics in consumer packaging displacing virgin plastics and providing more environmentally friendly and sustainable packaging options for brand owners;
d) Yet another advantage of the present invention is that it will divert a larger segment of plastics from landfills or incineration;
e) Yet another advantage of the present invention is that the process does not require sorting of plastics by municipalities and MRFs reducing the cost of recycling for municipalities;
f) Yet another advantage of the present invention is that the process can be used to incorporate most functional or non-functional additive into most recycled or virgin plastics and/or a combination thereof without the need of an additional melt history;
g) Yet another advantage of the present invention is that the process can result in compounded recycled or virgin plastics and/or a combination thereof where the compounded pellet may include most additives and/or fillers, and/or pigments commonly used in the art of compounding plastics and also meet food packaging regulations;
h) Yet another advantage of the present invention specific to the production of CPET pellets herein disclosed is that coloured PET packaging and thermoform PET packaging for which there is little to no recycling potential to-date can be used to produce a high value consumer packaging product such as “dual ovenable” CPET trays;
i) Yet another advantage of the present invention specific to the production of CPET pellets herein disclosed is that it can be used to increase the molecular weight of the PET chains to desired levels for any particular application;
j) Yet another advantage of the present invention specific to the production of CPET pellets herein disclosed is that most nucleators, and/or functional or non-functional additive, and/or pigments, and/or fillers desired can be incorporated in the CPET formulation;
k) Yet another advantage of the present invention specific to the production of CPET pellets herein disclosed is that the CPET pellets produced could be tailored to be suitable for either “roll-fed” and/or “melt to mold” and or any other thermoforming process that is well known in the art of production of thermoform “dual ovenable” packaging;
l) Yet another advantage of the present invention specific to the production of CPET pellets herein disclosed is that the process from feedstock to final product is economically competitive for the production of CPET pellets.

The above disclosure generally describes the present invention. Changes in form and substitution of equivalents are contemplated as circumstances may suggest or render expedient. Although specific terms have been employed herein, such terms are intended in a descriptive sense and not for purposes of limitation. Other variations and modifications of the invention are possible. As such modifications or variations are believed to be within the sphere and scope of the invention as defined by the claims appended hereto.

1. (canceled)

2. A method of processing recycled plastic materials from a mixed rigid plastic bale for an intended end-use application, wherein said method comprises: (a) providing a mixed rigid plastic bale, the mixed rigid plastic bale having a commingled mixture of various plastic resins and colours, (b) breaking the mixed plastic bale apart to obtain mixed rigid plastics; (c) sorting the mixed rigid plastics into one or more streams of plastic materials, said sorting including resin type and physical properties of the plastic materials in the mixed rigid plastics; (d) washing one or more of the streams of plastic materials to obtain clean flakes of plastic material in each stream; (e) comminuting the plastic flakes in one or more of the streams into particles of plastic material; and (f) compounding the particles of plastic material in one or more of the streams to obtain one or more plastic products configured for the intended end-use application.

3. The method of claim 2, wherein said mixed rigid bale includes polyethylene terephthalate (PET), high-density polyethylene (HDPE), polyvinyl chloride (PVC), low-density polyethylene (LDPE), polypropylene (PP), polystyrene (PS) or any other type of plastics commonly found in consumer product packaging.

4. The method of claim 2, wherein said plastic material or plastic flake is PET and said compounding comprises increasing the intrinsic viscosity (IV) of the particles of PET, and pelletizing the particles of PET having increased IV to obtain plastic pellets for the intended end-use application.

5. The method of claim 2, wherein said compounding comprises (i) blending the particles with one or more additives to obtain a plastic blend and (ii) pelletizing the plastic blend to obtain plastid pellets for the intended end-use application.

6. The method of claim 2, wherein one of said one or more streams of plastic material is PET and said compounding comprises decontaminating the particles of PET, increasing the intrinsic viscosity of the particles of PET, blending the particles of PET with one or more additives, and pelletizing the blend to obtain PET pellets for the intended end-use application.

7. The method of claim 5, wherein said additives include crystallization nucleating agents, impact modifiers, thermal stabilizers, pigments and fillers.

8. The method of claim 7, wherein said crystallization nucleating agents include talc, gypsum, silica, calcium carbonate, alumina, titanium dioxide, calcium silicate, fine metal particles, powdered glass, carbon black, mica, graphite, salt of monocarboxylic or polycarboxylic acids, chlorobenzoates, benzophenone, alkylsulfonates, dibenzylidene, sorbitol compounds, alkyl aryl phosphates, cyclic bis-phenol phosphates, acetals of sorbitol and xylitiol, remnants of polycondensation catalyst, polymers comprising polyolefins, various copolymers of ethylene, and styrene derivatives, ionomers, blends of faster crystallizing polymers like PET, PBN, PA, individually or mixtures of one or more.

9. The method of claim 7, wherein said impact modifiers include terpolymers.

10. The method of claim 6, wherein said additives include crystallization nucleating agents, impact modifiers, thermal stabilizers, pigments and fillers.

11. The method of claim 10, wherein the impact modifiers include: calcium carbonate, elastomers, rubbers, polyolefins including PP or HDPE with GMS (glycidyl Methylacrylate) as compatibilizers, and terpolymers combined with methylacrylate compatibilizers.

12. The method of claim 7, wherein said thermal stabilizers include: terephthalic acid (TA), phthalimide (PTI), dimethyl terephthalate (DMT), 4-hydroxy benzoic acid (HBA), 5-hydroxy isophthalic add (HIPA), 3,5-dihydroxybenzoic add (DHBA), phenyl isocyonate (PIC), phthalic anhydride (PA), 4-aminobenozic acid (PAB), resorcinol (ROL), or diphenylamine (DPA).

13. The method of claim 2, wherein said intended end-use application is the production of dual ovenable food packaging.

14. A method for producing crystallized polyethylene terephthalate (CPET) from a mixed rigid plastic bale having a commingled mixture of various plastic resins and colours, wherein the method comprises:
(a) providing the mixed rigid plastic bale;
(b) breaking the mixed rigid plastic bale apart;
(c) sorting polyethylene terephthalate (PET) plastics from the broken mixed rigid plastic bale into a stream of PET;
(d) washing the PET streams to obtain dean PET flakes;
(e) comminuting the PET flakes into particles;
(f) blending the PET particles with a sufficient amount of one or more nucleating agents to obtain a blend; and
(g) pelletizing the blend into CPET pellets, thereby providing CPET from recovered PET flakes.

15. The method of claim 14, wherein step (e) comprises blending the PET particles with recycled polyethylene (PE) or recycled polypropylene (PP).

16. The method of claim 15, wherein the recycled PE or recycled PP are recovered through the method of claim 2.

17. The method of claim 14, wherein said method is devoid of a melting step of the PET.

18. The method of claim 1, wherein said method is devoid of a melting step of the plastic materials.
